(19) United States
(12) Patent Application Publication
(10) Pub. No.: US 2016/0313135 A1
(43) Pub. Date: Oct. 27, 2016

(54) METHOD, PORTABLE TERMINAL, IN-VEHICLE TERMINAL AND SYSTEM FOR VEHICLE POSITIONING

(71) Applicant: Beijing Sunplus-EHue Tech Co., Ltd., Beijing (CN)

(72) Inventors: Xiao-Peng CHEN, Beijing (CN); Tai-Yun WANG, Beijing (CN)

(73) Assignee: Beijing Sunplus-EHue Tech Co., Ltd., Beijing (CN)

(21) Appl. No.: 15/047,220

(22) Filed: Feb. 18, 2016

(30) Foreign Application Priority Data
Apr. 21, 2015 (CN) 201510191823.1

(51) Int. Cl. G01C 21/36; G01S 19/13

(52) U.S. Cl. CPC G01C 21/36; G01S 19/13

(57) ABSTRACT

The present invention provides a method, a portable terminal, an in-vehicle terminal and a system for vehicle positioning. The portable terminal is connected to an in-vehicle GPS terminal. The method includes: receiving and processing a vehicle inertial positioning information transmitted from the in-vehicle GPS terminal; obtaining a vehicle coordinate information and a vehicle driving information according to the processed vehicle inertial positioning information; combining the vehicle coordinate information and the vehicle driving information with a navigation map of the portable terminal; and generating a navigation image according to the navigation map, the vehicle coordinate information and the vehicle driving information. The present invention can implement navigation function without purchasing or upgrading vehicle navigation software.

This invention claims the benefit of People's Republic of China application Serial No. 201510191823.1, filed Apr. 21, 2015, the disclosure of which is incorporated by reference herein in its entirety.

### TECHNICAL FIELD

The disclosure relates in general to the technical field of vehicle positioning technology, and more particularly to a method, a portable terminal, a vehicle-mounted terminal and a system for use in vehicle positioning.

### BACKGROUND

Global positioning system (GPS) is a navigation system using GPS positioning satellites to perform real-time global positioning and navigation. GPS, which provides highly accurate navigation information in terms of 3D position, speed and time setting at low cost for global users, is an exemplary model of using satellite communication technology in the field of navigation.

Currently available in-vehicle GPS terminals are capable of calculating the current position according to the positioning function, gyroscopes and vehicle speed sensor, combining the current position with the map information of surrounding environment of a vehicle, and providing the combined map information to navigate the drivers. Along with the advance in the portable terminal technology, the navigation function can also be implemented through the GPS positioning function of a portable terminal.

The Chinese Patent Publication No. CN101855518 published on Oct. 6, 2010 disclosed ‘POSITIONING SYSTEM AND IN-VEHICLE DEVICE’. According to the patent CN101855518, an in-vehicle-side positioning unit obtains in-vehicle-side positioning data, a portable-side positioning unit obtains portable-side positioning data, and one of the in-vehicle-side positioning data and the portable-side positioning data is selected to obtain a more accurate positioning coordinate to obtain a vehicle position. However, the user needs to purchase vehicle navigation software for in-vehicle-side navigation function. In addition, the speed of the vehicle navigation software in updating is slow. The update of the vehicle navigation software is available only through 4S shops, and the cost for updating the vehicle navigation software is high. Therefore, the technology disclosed in CN101855518 cannot resolve the problem of in-vehicle-side navigation software merely based on the selection between the in-vehicle-side positioning data and the portable-side positioning data. Moreover, if the portable-side is not equipped with positioning function, the technology disclosed in CN101855518 cannot obtain the portable-side positioning data.

Therefore, how to resolve the problems of purchasing and upgrading the in-vehicle-side navigation software has become a prominent task in the technical field of vehicle positioning technology.

### SUMMARY

The present invention is directed to a method, a portable terminal, an in-vehicle terminal and a system for vehicle positioning. The present invention is capable of providing navigation function without purchasing or upgrading the in-vehicle navigation software.

To achieve one of the above objects, following technical solutions are adopted in the embodiments of the present invention.

According to one embodiment of the present invention, a vehicle positioning method used on a portable terminal connected to an in-vehicle GPS terminal is provided. The method includes: receiving and processing a vehicle inertial positioning information transmitted from the in-vehicle GPS terminal; obtaining a vehicle coordinate information and a vehicle driving information according to the processed vehicle inertial positioning information; combining the vehicle coordinate information and the vehicle driving information with a navigation map of the portable terminal; and generating a navigation image according to the navigation map, the vehicle coordinate information and the vehicle driving information.

Furthermore, step of receiving and processing the vehicle inertial positioning information transmitted from the in-vehicle GPS terminal further includes: turning off the positioning function of the portable terminal to stop receiving the positioning information of the portable terminal.

Furthermore, step of receiving and processing the vehicle inertial positioning information transmitted from the in-vehicle GPS terminal further includes: receiving at least one of American GPS positioning information, Russian GLONASS positioning information, European Union GALILEO positioning information and Chinese Beidou positioning information, and using the received positioning information as the positioning information of the portable terminal.

Furthermore, the positioning information of the portable terminal further includes a vehicle front-end orientation information of the in-vehicle GPS terminal.

Furthermore, the method further includes: receiving a local information request from the in-vehicle GPS terminal; and transmitting the received local information to the in-vehicle GPS terminal.

Furthermore, the vehicle driving information includes a wheel speed and a vehicle orientation angle.

Furthermore, the method further includes: receiving a traffic condition information from the in-vehicle GPS terminal; and step of generating the navigation image according to the navigation map, the vehicle coordinate information and the vehicle driving information is implemented by generating and displaying the navigation image according to the traffic condition information, the navigation map, the vehicle coordinate information and the vehicle driving information.

Furthermore, the method further includes: transmitting the navigation image to the in-vehicle GPS terminal for display.

The present invention further provides a vehicle positioning method used on an in-vehicle GPS terminal connected to a portable terminal. The method includes: transmitting a vehicle inertial positioning information to the portable terminal; and receiving and displaying the navigation map, the vehicle coordinate information and the navigation image transmitted from the portable terminal.

Furthermore, the method further includes: transmitting a local information request to the portable terminal; and receiving a local information from the portable terminal.

Furthermore, the method further includes: transmitting an obtained traffic condition information to the portable terminal.

The present invention further provides a vehicle positioning method used in a system, in which portable terminal is connected to an in-vehicle GPS terminal. The method includes: transmitting a vehicle inertial positioning information to the portable terminal from the in-vehicle GPS terminal; receiving and processing a vehicle inertial positioning information transmitted from the in-vehicle GPS terminal by the portable terminal; obtaining a vehicle coordinate information and a vehicle driving information according to the processed vehicle inertial positioning information; combining the vehicle coordinate information and the vehicle driving information with a navigation map of the portable terminal; generating and displaying a navigation image according to the navigation map, the vehicle coordinate information and the vehicle driving information; and receiving and displaying, by the in-vehicle GPS terminal, the navigation map, the vehicle coordinate information and the navigation image transmitted from the portable terminal.

The present invention further provides a portable terminal connected to an in-vehicle GPS terminal for vehicle positioning. The portable terminal includes: an information receiving module used for receiving and processing a vehicle inertial positioning information transmitted from the in-vehicle GPS terminal; an information obtaining module used for obtaining a vehicle coordinate information and a vehicle driving information according to the processed vehicle inertial positioning information; a map combining module used for combining the vehicle coordinate information and the vehicle driving information with a navigation map of the portable terminal; and an image generating module used for generating a navigation image according to the navigation map, the vehicle coordinate information and the vehicle driving information.

Furthermore, the information receiving module is further used for turning off a positioning function of the portable terminal to stop receiving a positioning information of the portable terminal.

Furthermore, the information receiving module is further used for receiving at least one of American GPS positioning information, Russian GLONASS positioning information, European Union GALILEO positioning information, and Chinese Beidou positioning information, and using the received positioning information as a positioning information of the portable terminal.

Furthermore, the positioning information of the portable terminal further includes a vehicle front-end orientation of the in-vehicle GPS terminal.

The portable terminal further includes: an information requesting module used for receiving a local information request from the in-vehicle GPS terminal; and an information providing module used for transmitting the received local information to the in-vehicle GPS terminal.

Furthermore, the vehicle driving information includes a wheel speed and a vehicle orientation angle.

The portable terminal further includes: a traffic condition receiving module used for receiving a traffic condition information from the in-vehicle GPS terminal; and the image generating module is used for generating a navigation image according to the traffic condition information, the navigation map, the vehicle coordinate information and the vehicle driving information.

The portable terminal further includes: an image displaying module used for transmitting the navigation image to the in-vehicle GPS terminal for display.

The present invention further provides an in-vehicle GPS terminal for vehicle positioning, wherein the in-vehicle GPS terminal is connected to a portable terminal and includes: an information transmitting module used for transmitting a vehicle inertial positioning information to the portable terminal; and a navigation display module used for receiving and displaying a navigation map, a vehicle coordinate information and a navigation image transmitted from the portable terminal.

The in-vehicle GPS terminal further includes: an instruction transmitting module used for transmitting a local information request to the portable terminal; and a local receiving module used for receiving a local information from the portable terminal.

The in-vehicle GPS terminal further includes: a traffic condition obtaining module used for transmitting an obtained traffic condition information to the portable terminal.

The present invention further provides a vehicle positioning system including a portable terminal and an in-vehicle GPS terminal.

The portable terminal includes; an information receiving module used for receiving and processing a vehicle inertial positioning information transmitted from the in-vehicle GPS terminal; an information obtaining module used for obtaining a vehicle coordinate information and a vehicle driving information according to the processed vehicle inertial positioning information; a map combining module used for combining the vehicle coordinate information and the vehicle driving information with a navigation map of the portable terminal; an image generating module used for generating a navigation image according to the navigation map, the vehicle coordinate information and the vehicle driving information.

The in-vehicle GPS terminal includes: an information transmitting module used for transmitting a vehicle inertial positioning information to the portable terminal; and a navigation display module used for receiving and displaying the navigation map, the vehicle coordinate information and the navigation image transmitted from the portable terminal.

As indicated in the above technical solutions of the present invention, the vehicle inertial positioning information obtained by the in-vehicle GPS terminal is transmitted to the portable terminal so as to obtain a vehicle coordinate information and a vehicle driving information. A navigation image is generated and displayed according to a navigation map which is generated by navigation software installed on a portable terminal in conjunction with the vehicle coordinate information and the vehicle driving information. Thus, the in-vehicle GPS terminal of the present invention can utilize the navigation software installed on the portable terminal which is connected to the in-vehicle GPS terminal to achieve vehicle navigation function by providing a vehicle inertial positioning information. Moreover, the present invention is convenient to use at lower cost.

The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a portable terminal according to the present invention;

FIG. 2 is a flowchart of a vehicle positioning method according to an embodiment of the present invention;

FIG. 3 is a flowchart of a vehicle positioning method according to an alternate embodiment of the present invention;

FIG. 4 is a flowchart of a vehicle positioning method according to another embodiment of the present invention;

FIG. 5 is a flowchart of a vehicle positioning method according to another embodiment of the present invention;

FIG. 6 is a block diagram of an in-vehicle GPS terminal according to the present invention;

FIG. 7 is a flowchart of a vehicle positioning method according to another embodiment of the present invention;

FIG. 8 is a flowchart of a vehicle positioning method according to another embodiment of the present invention;

FIG. 9 is a flowchart of a vehicle positioning method according to another embodiment of the present invention;

FIG. 10 is a flowchart of a vehicle positioning method according to another embodiment of the present invention;

FIG. 11 is a block diagram of a portable terminal for vehicle positioning according to an embodiment of the present invention;

FIG. 12 is a block diagram of a portable terminal for vehicle positioning according to an alternate embodiment of the present invention;

FIG. 13 is a block diagram of a portable terminal for vehicle positioning according to another embodiment of the present invention;

FIG. 14 is a block diagram of a portable terminal for vehicle positioning according to another embodiment of the present invention;

FIG. 15 is a block diagram of an in-vehicle GPS terminal for vehicle positioning according to an embodiment of the present invention;

FIG. 16 is a block diagram of an in-vehicle GPS terminal for vehicle positioning according to an alternate embodiment of the present invention;

FIG. 17 is a block diagram of an in-vehicle GPS terminal for vehicle positioning according to another embodiment of the present invention;

FIG. 18 is a block diagram of a vehicle positioning system of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

According to the present invention, a vehicle inertial positioning information obtained by an in-vehicle GPS terminal is transmitted to a portable terminal so as to obtain a vehicle coordinate information and a vehicle driving information. A navigation image is generated and displayed according to a navigation map which is generated by the navigation software installed on the portable terminal in conjunction with the vehicle coordinate information and the vehicle driving information. Thus, the in-vehicle GPS terminal of the present invention can utilize the navigation software installed on the portable terminal which is connected to the in-vehicle GPS terminal to achieve vehicle navigation function by providing a vehicle inertial positioning information. Moreover, the present invention is convenient to use at lower cost.

The implementation of any one of the technical solutions of the present invention does not have to achieve all of the above features at the same time.

For any person ordinarily skilled in the present technical field of technology to better understand the technical solutions of the present invention, the technical solutions disclosed in the embodiments of the present invention are fully described with reference to accompanying drawings. It should be understood that the embodiments disclosed in the present invention are merely a portion, not an entirety, of the embodiments. Based on the embodiments disclosed in the present invention, any person ordinarily skilled in the present technical field of technology shall be able to obtain other embodiments not disclosed in the present invention, and these embodiments are still within the scope of protection of the present invention.

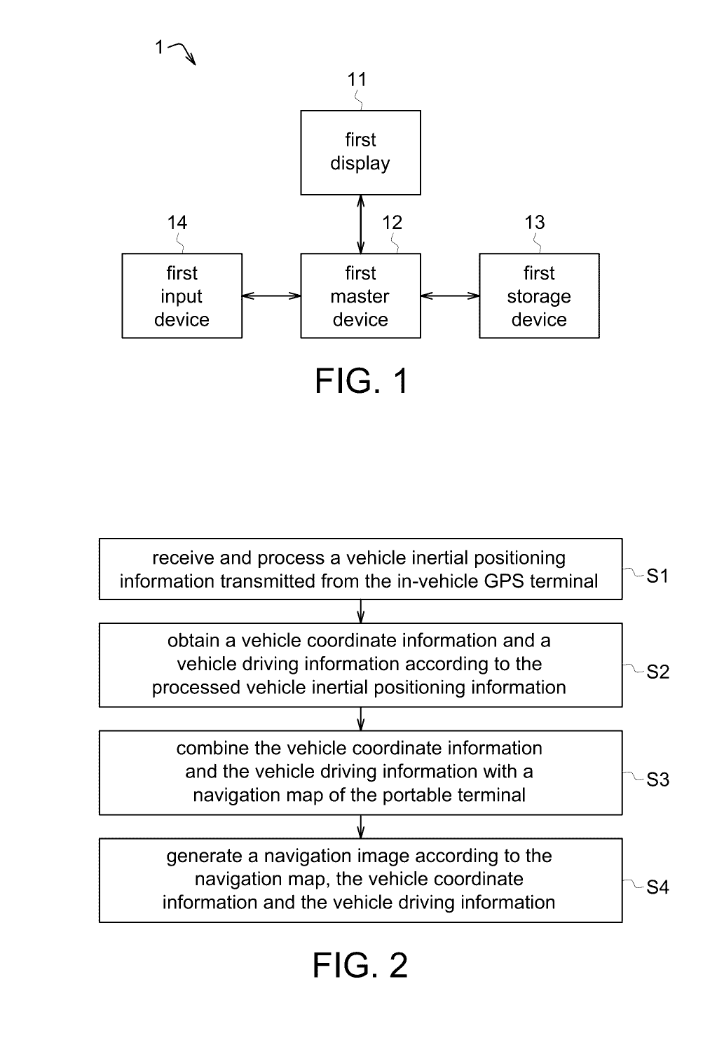

According to an embodiment of the present invention, a vehicle positioning method used in a portable terminal connected to an in-vehicle GPS terminal is provided. Refer to FIG. 1. The portable terminal 1, such as a mobile phone, generally includes a first display 11, a first master device 12, a first storage device 13, and a first input device 14.

Refer to FIG. 2. The method of the present invention includes the following steps.

In step S1, a vehicle inertial positioning information transmitted from the in-vehicle GPS terminal is received and processed.

The portable terminal and the in-vehicle GPS terminal are generally connected by a USB interface through which data can be transferred between the portable terminal and the in-vehicle GPS terminal. In practical implementation, data transfer can be achieved by way of wireless communication such as Wi-Fi or Bluetooth. The portable terminal receives a vehicle inertial positioning information from the in-vehicle GPS terminal. For the convenience of data transfer, the vehicle inertial positioning information is generally compressed and encoded. Then, the portable terminal further decodes the received vehicle inertial positioning information. Besides, the portable terminal further performs error correction on the decoded vehicle inertial positioning information to eliminate the errors which occur in the vehicle inertial positioning information due to ambient environment reflections. Practical algorithms are the same as existing error correction of the positioning information, and are not repeated here.

In step S2, a vehicle coordinate information and a vehicle driving information is obtained according to the processed vehicle inertial positioning information.

The portable terminal analyzes the vehicle inertial positioning information to obtain the vehicle coordinate information and the vehicle driving information. Specifically, the vehicle coordinate information is a current coordinate position calculated according to the positioning function, the gyroscopes and the speed sensor of the vehicle. In general, the vehicle coordinate information is a 3D coordinate position information. The vehicle driving information includes a wheel speed and a vehicle orientation angle, and may further include other information such as fuel situation and current hourly speed.

In step S3, the vehicle coordinate information and the vehicle driving information are combined with a navigation map of the portable terminal.

Since the portable terminal, such as a smart phone, is usually equipped with navigation software, the equipped navigation software provides more accurate navigation accuracy, is updated more quickly and is more convenient. The portable terminal can use the equipped navigation software to generate a navigation map and further combine the vehicle coordinate information and the vehicle driving information with the generated navigation map.

In step S4, a navigation image is generated according to the navigation map, the vehicle coordinate information and the vehicle driving information.

The image generated by the portable terminal according to the navigation map, the vehicle coordinate information and the vehicle driving information is referred as a navigation image.

In another embodiment of the present invention, the method includes steps S1-S4. Specifically, step S1 further includes: turning off the positioning function of the portable terminal to stop receiving the positioning information of the portable terminal.

In the present embodiment, the portable terminal can be realized by a portable terminal not equipped with positioning function, such as a low-price PDA. The portable terminal can also be realized by a portable terminal equipped with positioning function. However, in the present embodiment, the positioning function of the portable terminal is turned off, such that the portable terminal stops receiving the positioning information from the satellite. The present invention can save power consumption. For example, the connection between the portable terminal and the in-vehicle GPS terminal via a USB interface not only increases charging speeds of the portable terminal, but also reduces the heat generated by the portable terminal and increases the reliability of overall operation.

In another embodiment of the present invention, the method includes steps S1-S4. Specifically, step S1 further includes: receiving at least one of American GPS positioning information, Russian GLONASS positioning information, European Union GALILEO positioning information and Chinese Beidou positioning information, and using the received positioning information as a positioning information of the portable terminal.

Thus, the positioning information of the portable terminal can be combined with the positioning information of the in-vehicle GPS terminal to provide more accurate positioning information. Meanwhile, when the in-vehicle GPS terminal cannot receive any positioning information from the satellite (for example, the in-vehicle GPS terminal is located at an underground parking lot), the in-vehicle GPS terminal can perform navigation by using the positioning information of the portable terminal.

Specifically, the positioning information of the portable terminal further includes a vehicle front-end orientation information of the in-vehicle GPS terminal, and a vehicle driving direction can be obtained according to the vehicle front-end orientation information to provide more accurate positioning information for subsequent navigation.

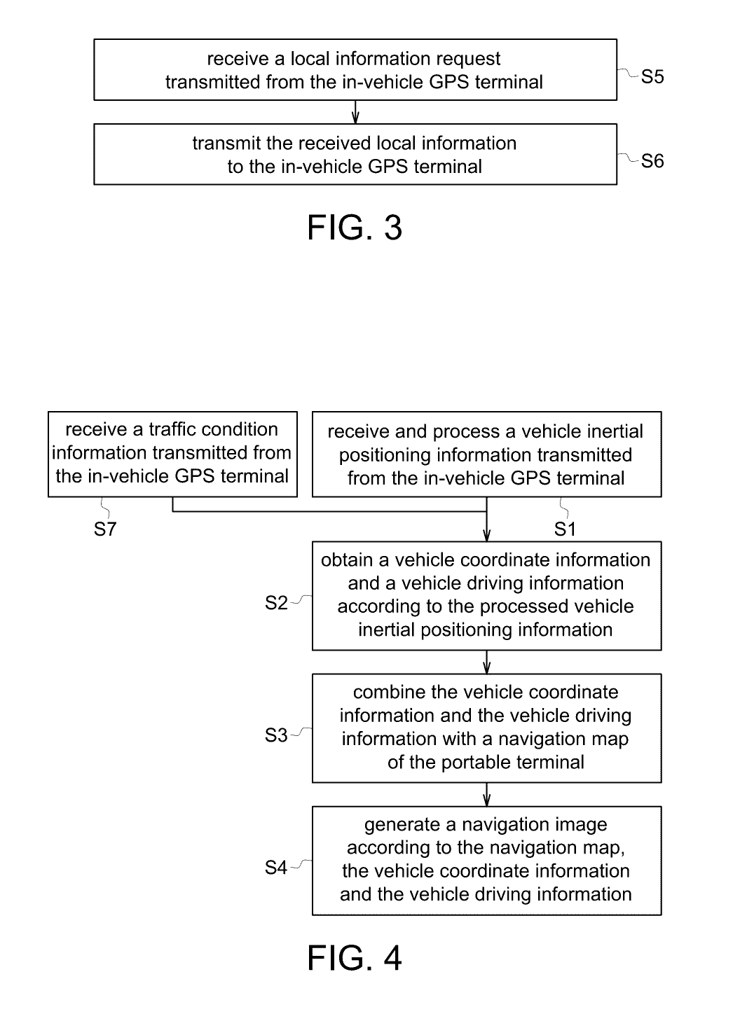

In another embodiment of the present invention, the method includes steps S1-S4. Refer to FIG. 3, the method further includes following steps.

In step S5, a local information request is received from the in-vehicle GPS terminal.

In step S6, the received local information is transmitted to the in-vehicle GPS terminal.

In the present embodiment, in order to obtain more accurate positioning information, the in-vehicle GPS terminal can transmit a local information request to the portable terminal to obtain a local information by using Wi-Fi or cell ID function of the portable terminal. The portable terminal transmits the obtained local information to the in-vehicle GPS terminal, such that the in-vehicle GPS terminal can achieve more accurate local positioning.

In another embodiment of the present invention, the method includes steps S1-S4. Specifically, refer to FIG. 4. The method further includes following step.

In step S7, a traffic condition information is received from the in-vehicle GPS terminal.

Step S4 can be implemented by generating a navigation image according to the traffic condition information, the navigation map, the vehicle coordinate information and the vehicle driving information.

The in-vehicle GPS terminal can obtain a traffic condition information via the Traffic Message Channel (TMC) service on FM radio or the Internet. The traffic condition information includes information related to traffic congestion, road traffic regulation or road maintenance in each road section. The information of traffic congestion, road traffic regulation or road maintenance in each road section is marked in the generated navigation image according to the traffic condition information to provide a better route selection.

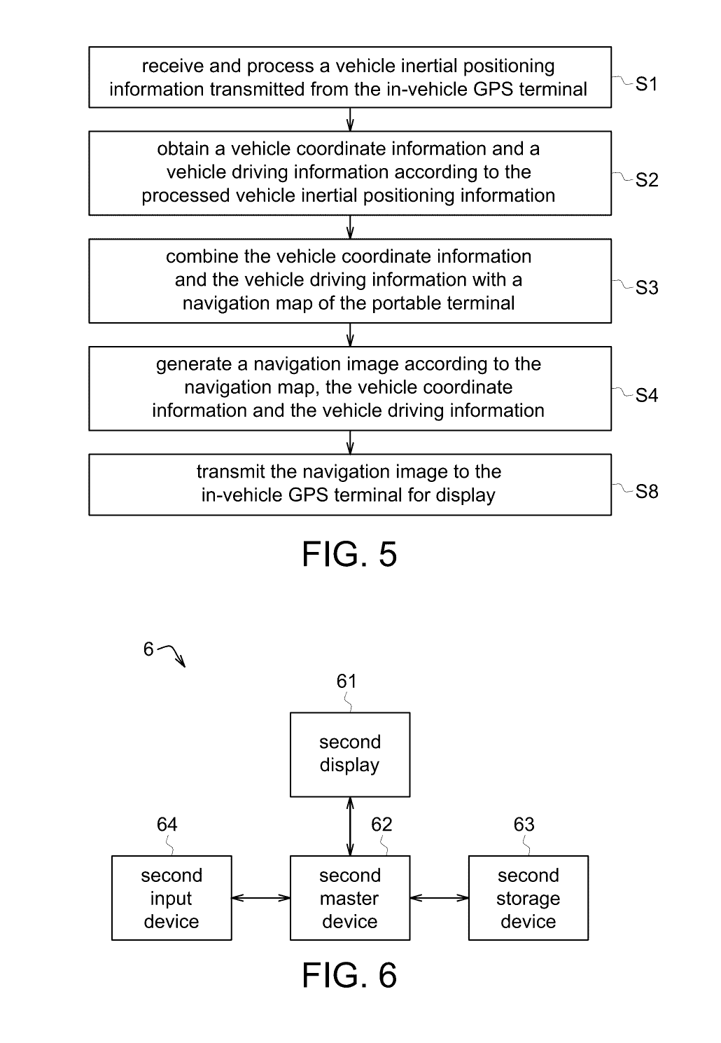

In another embodiment of the present invention, the method includes steps S1-S4. Specifically, refer to FIG. 5. The method further includes following step.

In step S8, the navigation image is transmitted to the in-vehicle GPS terminal for display.

The display screen of the in-vehicle GPS terminal is usually larger than that of the portable terminal and therefore is capable of providing better display effect. According to the present invention, the navigation image generated by the portable terminal is transmitted to the in-vehicle GPS terminal for display to provide better navigation function to the drivers.

A vehicle positioning method used in an in-vehicle GPS terminal connected to a portable terminal is provided in an embodiment of the present invention. Refer to FIG. 6. The in-vehicle GPS terminal 6 usually includes a second display 61, a second master device 62, a second storage device 63, and a second input device 64 in terms of hardware.

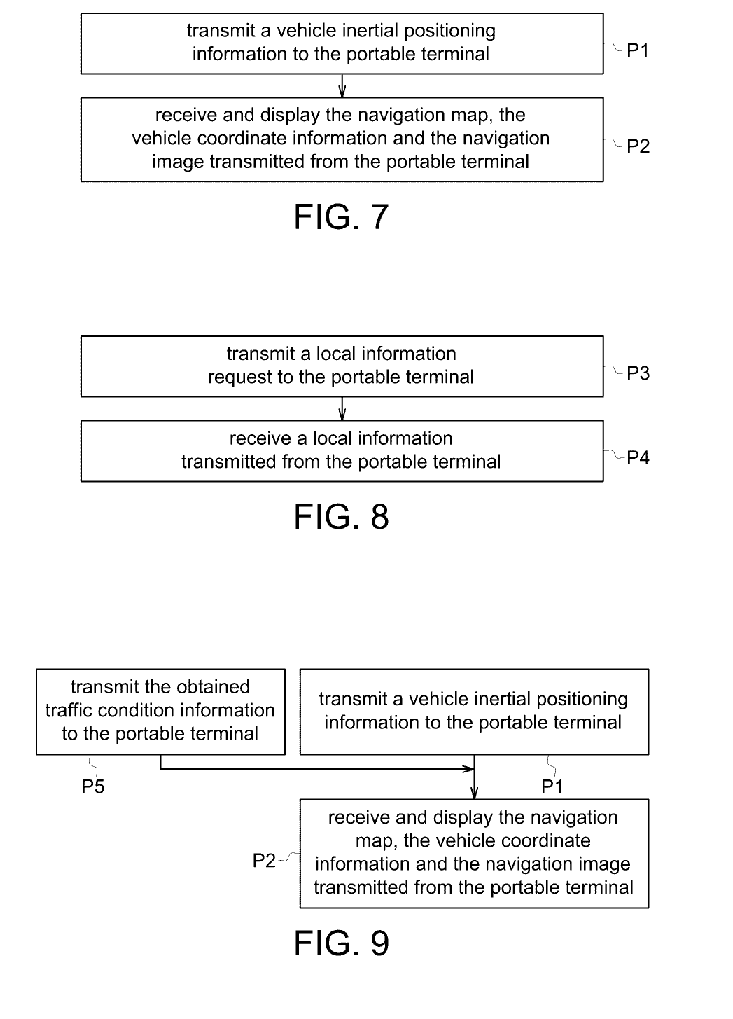

Refer to FIG. 7. The method of the present invention includes following steps.

In step P1, a vehicle inertial positioning information is transmitted to the portable terminal.

The portable terminal and the in-vehicle GPS terminal are usually connected by a USB interface to transfer data between the portable terminal and the vehicle-mounted GPS terminal. In practical implementation, data transfer can be achieved by way of wireless communication such as Wi-Fi or Bluetooth. The in-vehicle GPS terminal transmits a vehicle inertial positioning information. For the convenience of data transfer, the vehicle inertial positioning information is usually compressed and encoded. The portable terminal decodes the received vehicle inertial positioning information.

In step P2, the navigation map, the vehicle coordinate information and the navigation image transmitted from the portable terminal are received and displayed.

The display screen of the in-vehicle GPS terminal is usually larger than that of the portable terminal and therefore is capable of providing better display effect. According to the present invention, the navigation image generated by the portable terminal is transmitted to the in-vehicle GPS terminal for display to provide better navigation function to the drivers.

In another embodiment of the present invention, the method includes steps P1-P2. Specifically, refer to FIG. 8. The method further includes following steps.

In step P3, a local information request is transmitted to the portable terminal.

In step P4, a local information is received from the portable terminal.

In the present embodiment, in order to obtain more accurate positioning information, the in-vehicle GPS terminal can transmit a local information request to the portable terminal to obtain a local information by using Wi-Fi or cell ID function of the portable terminal. The portable terminal transmits the obtained local information to the in-vehicle GPS terminal, such that the in-vehicle GPS terminal can achieve more accurate local positioning.

In another embodiment of the present invention, the method includes steps P1-P4. Specifically, refer to FIG. 9. The method further includes following step.

In step P5, the obtained traffic condition information is transmitted to the portable terminal.

The in-vehicle GPS terminal can obtain a traffic condition information via the Traffic Message Channel (TMC) service on FM radio or the Internet. The traffic condition information includes information related to traffic congestion, road traffic regulation or road maintenance in each road section.

The present invention further provides a vehicle positioning method used in a system, in which a portable terminal is connected to an in-vehicle GPS terminal. The hardware structures of the portable terminal and the in-vehicle GPS terminal are as described above, and are not repeated here.

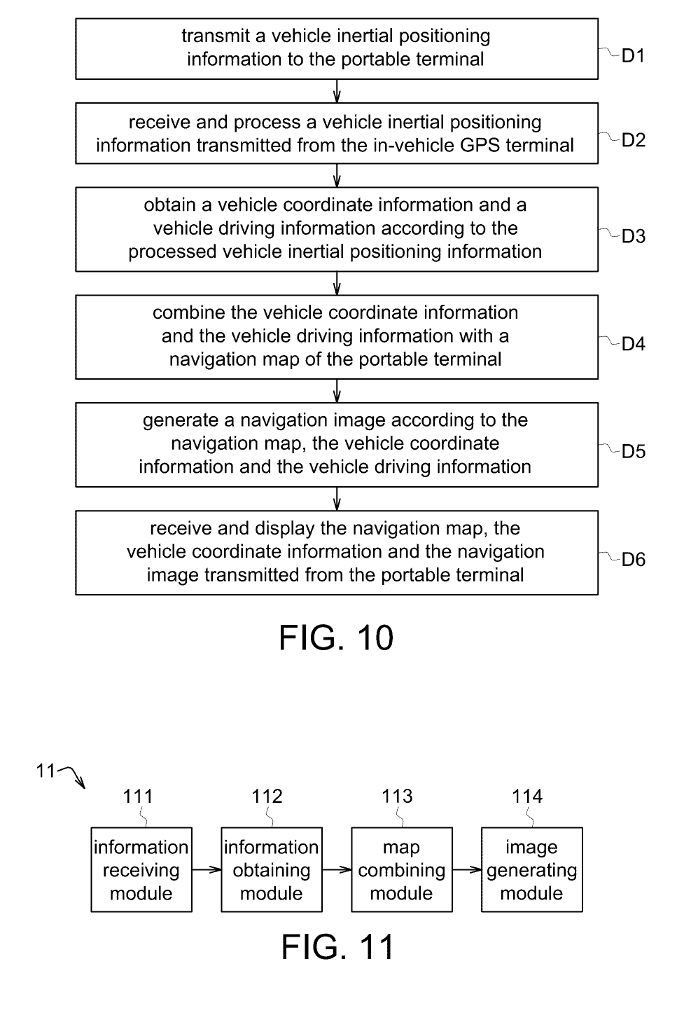

Refer to FIG. 10. The method includes following steps.

In step D1, the in-vehicle GPS terminal transmits a vehicle inertial positioning information to the portable terminal.

The portable terminal and the in-vehicle GPS terminal are usually connected by a USB interface through which data can be transferred between the portable terminal and the vehicle-mounted GPS terminal. In practical implementation, data transfer can be achieved by way of wireless communication such as Wi-Fi or Bluetooth. The in-vehicle GPS terminal transmits a vehicle inertial positioning information. For the convenience of data transfer, the vehicle inertial positioning information is usually compressed and encoded. The portable terminal decodes the received vehicle inertial positioning information.

In step D2, the vehicle inertial positioning information transmitted from the in-vehicle GPS terminal is received and further processed by the portable terminal.

The portable terminal and the in-vehicle GPS terminal are usually connected by a USB interface through which data can be transferred between the portable terminal and the vehicle-mounted GPS terminal. In practical implementation, data transfer can be achieved by way of wireless communication such as Wi-Fi or Bluetooth. The portable terminal receives the vehicle inertial positioning information transmitted from the in-vehicle GPS terminal. For the convenience of data transfer, the vehicle inertial positioning information is usually compressed and encoded. The portable terminal decodes the received vehicle inertial positioning information. Besides, the portable terminal further performs error correction on the decoded vehicle inertial positioning information to eliminate the errors which occur in the vehicle inertial positioning information due to ambient environment reflections. Practical algorithms are the same as existing error correction of the positioning information, and are not repeated here.

In step D3, a vehicle coordinate information and a vehicle driving information are obtained according to the processed vehicle inertial positioning information.

The portable terminal analyzes the vehicle inertial positioning information to obtain the vehicle coordinate information and the vehicle driving information. Specifically, the vehicle coordinate information is a current coordinate position calculated according to the positioning function, the gyroscopes and the speed sensor of the vehicle. In general, the vehicle coordinate information is a 3D coordinate position information. The vehicle driving information includes a wheel speed and a vehicle orientation angle, and may further include other information such as fuel situation and current hourly speed.

In step D4, the vehicle coordinate information and the vehicle driving information are combined with a navigation map of the portable terminal.

Since the portable terminal, such as a smart phone, is usually equipped with navigation software, the equipped navigation software provides more accurate navigation accuracy, is updated more quickly and is more convenient. The portable terminal can use the equipped navigation software to generate a navigation map and further combine the vehicle coordinate information and the vehicle driving information with the generated navigation map.

In step D5, a navigation image is generated according to the navigation map, the vehicle coordinate information and the vehicle driving information.

The image generated by the portable terminal according to the navigation map, the vehicle coordinate information and the vehicle driving information is referred as a navigation image.

In step D6, the in-vehicle GPS terminal receives and displays the navigation map, the vehicle coordinate information and the navigation image transmitted from the portable terminal.

The display screen of the in-vehicle GPS terminal is normally larger than that of the portable terminal and therefore is capable of providing better display effect. According to the present invention, the navigation image generated by the portable terminal is transmitted to the in-vehicle GPS terminal for display to provide better navigation function to the drivers.

In response to the above method, the present invention provides a portable terminal connected to a vehicle-mounted GPS terminal for use in vehicle positioning. Refer to FIG. 1. The portable terminal 1, such as a mobile phone, usually includes a first display 11, a first master device 12, a first storage device 13 and a first input device 14 in terms of hardware.

Refer to FIG. 11. The portable terminal of the present invention includes an information receiving module 111, an information obtaining module 112, a map combining module 113, and an image generating module 114.

The information receiving module 111 is used for receiving and processing a vehicle inertial positioning information transmitted from the in-vehicle GPS terminal.

The information obtaining module 112 is used for obtaining a vehicle coordinate information and a vehicle driving information according to the processed vehicle inertial positioning information.

The map combining module 113 is used for combining the vehicle coordinate information and the vehicle driving information with a navigation map of the portable terminal.

The image generating module 114 is used for generating a navigation image according to the navigation map, the vehicle coordinate information and the vehicle driving information.

The portable terminal and the in-vehicle GPS terminal are usually connected by a USB interface to transfer data between the portable terminal and the in-vehicle GPS terminal. In practical implementation, data transfer can be achieved by way of wireless communication such as Wi-Fi or Bluetooth. The portable terminal receives a vehicle inertial positioning information transmitted from the in-vehicle GPS terminal. For the convenience of data transfer, the vehicle inertial positioning information is usually compressed and encoded. The portable terminal further decodes the received vehicle inertial positioning information. Besides, the portable terminal further performs error correction on the decoded vehicle inertial positioning information to eliminate the errors which occur in the vehicle inertial positioning information due to ambient environment reflections. Practical algorithms are the same as existing error correction of the positioning information, and are not repeated here.

The portable terminal analyzes the vehicle inertial positioning information to obtain a vehicle coordinate information and a vehicle driving information. Specifically, the vehicle coordinate information is a current coordinate position calculated according to the positioning function, the gyroscopes and the speed sensor of the vehicle. In general, the vehicle coordinate information is a 3D coordinate position information. The vehicle driving information includes a wheel speed and a vehicle front-end orientation angle of the vehicle, and may further include other information such as fuel situation and current hourly speed.

Since the portable terminal, such as a smart phone, is usually equipped with navigation software, the equipped navigation software provides more accurate navigation accuracy, is updated more quickly and is more convenient. The portable terminal can use the equipped navigation software to generate a navigation map and further combine the vehicle coordinate information and the vehicle driving information with the generated navigation map.

The image generated by the portable terminal according to the navigation map, the vehicle coordinate information and the vehicle driving information is referred as a navigation image.

In another embodiment of the present invention, the device includes an information receiving module 111, an information obtaining module 112, a map combining module 113, and an image generating module 114. Specifically, the information receiving module 111 is further used for turning off a positioning function of the portable terminal to stop receiving the positioning information of the portable terminal.

In the present embodiment, the portable terminal can be realized by a portable terminal not equipped with positioning function, such as a low-price PDA. The portable terminal can also be realized by a portable terminal equipped with positioning function. However, in the present embodiment, the positioning function of the portable terminal is turned off, such that the portable terminal stops receiving the positioning information from the satellite. The present invention can save power consumption. For example, the connection between the portable terminal and the in-vehicle GPS terminal via a USB interface not only increases the charging speeds of the portable terminal, but also reduces the heat generated by the portable terminal and increases the reliability of overall operation.

In another embodiment of the present invention, the device includes the information receiving module 111, the information obtaining module 112, the map combining module 113, and the image generating module 114 described above. Specifically, the information receiving module 111 is further used for receiving at least one of American GPS positioning information, Russian GLONASS positioning information, European Union GALILEO positioning information and Chinese Beidou positioning information, and further using the received positioning information as the positioning information of the portable terminal.

Thus, the positioning information of the portable terminal can be combined with the positioning information transmitted from the in-vehicle GPS terminal to provide more accurate positioning information. Meanwhile, when the in-vehicle GPS terminal cannot receive any positioning information from the satellite (for example, the in-vehicle GPS terminal is located at an underground parking lot), the in-vehicle GPS terminal can perform navigation by using the positioning information of the portable terminal.

Specifically, the positioning information of the portable terminal further includes a vehicle front-end orientation information of the in-vehicle GPS terminal, and a vehicle driving direction can be obtained according to the vehicle front-end orientation information to provide more accurate positioning information for subsequent navigation.

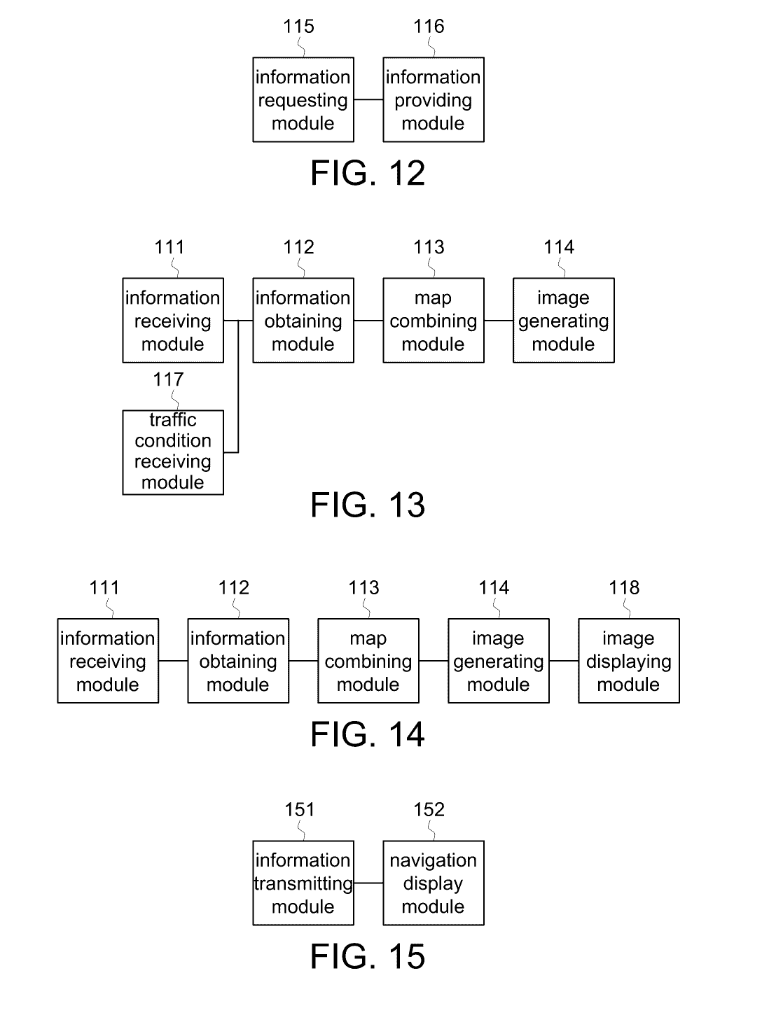

In another embodiment of the present invention, the device includes the information receiving module 111, the information obtaining module 112, the map combining module 113, and the image generating module 114 described above. Specifically, refer to FIG. 12. The device further includes an information requesting module 115 and an information providing module 116.

The information requesting module 115 is used for receiving a local information request from the in-vehicle GPS terminal.

The information providing module 116 is used for transmitting the received local information to the in-vehicle GPS terminal.

In the present embodiment, in order to obtain more accurate positioning information, the in-vehicle GPS terminal can transmit the local information request to the portable terminal to obtain a local information by using Wi-Fi or cell ID function of the portable terminal. The portable terminal transmits the received local information to the in-vehicle GPS terminal, such that the in-vehicle GPS terminal can achieve more accurate local positioning.

In another embodiment of the present invention, the device includes the information receiving module 111, the information obtaining module 112, the map combining module 113, and the image generating module 114 disclosed above. Refer to FIG. 13. The device further includes a traffic condition receiving module 117.

The traffic condition receiving module 117 is used for receiving a traffic condition information transmitted from the in-vehicle GPS terminal.

The image generating module 114 is used for generating a navigation image according to the traffic condition information, the navigation map, the vehicle coordinate information, and the vehicle driving information.

The in-vehicle GPS terminal can obtain a traffic condition information via the Traffic Message Channel (TMC) service on FM radio or the Internet. The traffic condition information includes information related to traffic congestion, road traffic regulation or road maintenance in each road section. The information of traffic congestion, road traffic regulation or road maintenance in each road section is marked in the generated navigation image according to the traffic condition information to provide a better route selection.

In another embodiment of the present invention, the device includes the information receiving module 111, the information obtaining module 112, the map combining module 113, and the image generating module 114 described above. Specifically, refer to FIG. 14. The device further includes an image displaying module 118.

The image displaying module 118 is used for transmitting the navigation image to the in-vehicle GPS terminal for display.

The display screen of the in-vehicle GPS terminal is usually larger than that of the portable terminal and therefore is capable of providing better display effect. According to the present invention, the navigation image generated by the portable terminal is transmitted to the in-vehicle GPS terminal for display to provide better navigation function to the drivers.

The present invention provides an in-vehicle GPS terminal for vehicle positioning. The in-vehicle GPS terminal is connected to a portable terminal. Refer to FIG. 6. The in-vehicle GPS terminal 6, such as a vehicle-mounted machine, usually includes a second display 61, a second master device 62, a second storage device 63, and a second input device 64 in terms of hardware.

Refer to FIG. 15. The vehicle positioning GPS terminal of the present invention includes an information transmitting module 151 and a navigation display module 152.

The information transmitting module 151 is used for transmitting a vehicle inertial positioning information to the portable terminal.

The navigation display module 152 is used for receiving and displaying the navigation map, the vehicle coordinate information and the navigation image transmitted from the portable terminal.

The portable terminal and the in-vehicle GPS terminal are usually connected via a USB interface through which data can be transferred between the portable terminal and the in-vehicle GPS terminal. In practical implementation, data transfer can be achieved by way of wireless communication such as Wi-Fi or Bluetooth. The in-vehicle GPS terminal transmits a vehicle inertial positioning information. For the convenience of data transfer, the vehicle inertial positioning information is usually compressed and encoded. The portable terminal decodes the received vehicle inertial positioning information.

The display screen of the in-vehicle GPS terminal is usually larger than that of the portable terminal and therefore is capable of providing better display effect. According to the present invention, the navigation image generated by the portable terminal is transmitted to the in-vehicle GPS terminal for display to provide better navigation function to the drivers.

In another embodiment of the present invention, the in-vehicle GPS terminal includes the information transmitting module 151 and the navigation display module 152 described above. Specifically, refer to FIG. 16. The in-vehicle GPS terminal further includes an instruction transmitting module 153 and a local receiving module 154.

The instruction transmitting module 153 is used for transmitting a local information request to the portable terminal.

The local receiving module 154 is used for receiving a local information transmitted from the portable terminal.

In the present embodiment, in order to obtain more accurate positioning information, the in-vehicle GPS terminal can transmit a local information request to the portable terminal to obtain a local information through Wi-Fi or cell ID function of the portable terminal. The portable terminal transmits the received local information to the in-vehicle GPS terminal, such that the in-vehicle GPS terminal can achieve more accurate local positioning.

In another embodiment of the present, the in-vehicle GPS terminal includes the information transmitting module 151 and the navigation display module 152 described above. Specifically, refer to FIG. 17. The in-vehicle GPS terminal further includes a traffic condition obtaining module 155.

The traffic condition obtaining module 155 is used for transmitting the obtained traffic condition information to the portable terminal.

The in-vehicle GPS terminal can obtain a traffic condition information via the Traffic Message Channel (TMC) service on FM radio or the Internet. The traffic condition information includes information related to traffic congestion, road traffic regulation or road maintenance in each road section.

The present invention further provides a vehicle positioning system including a portable terminal and an in-vehicle GPS terminal. The hardware structures of the portable terminal and the in-vehicle GPS terminal are as described above, and are not repeated here.

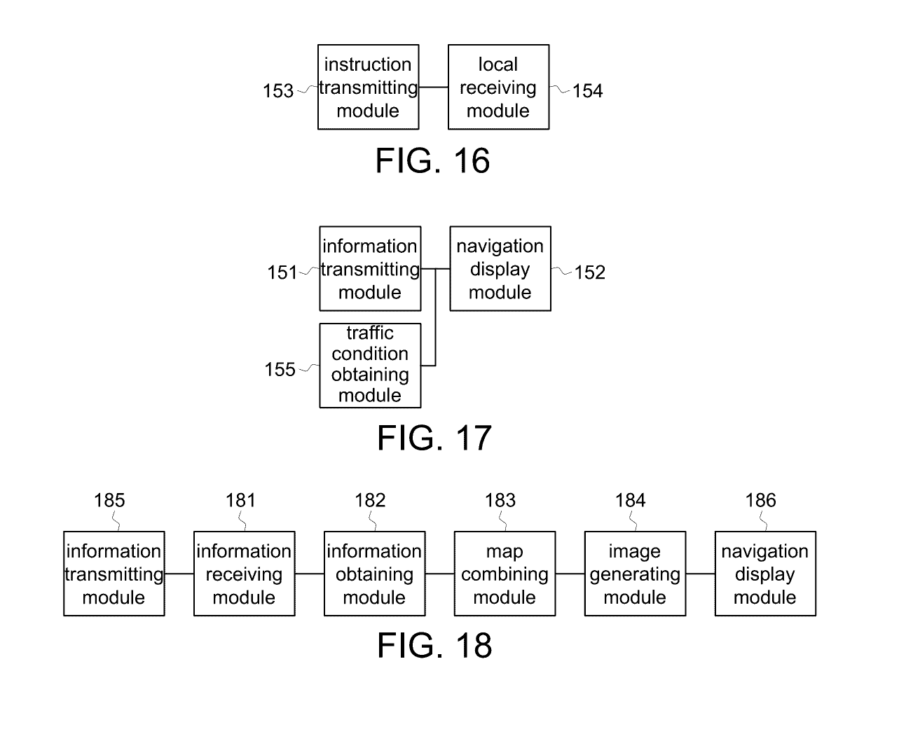

Refer to FIG. 18. The portable terminal includes an information receiving module 181, an information obtaining module 182, a map combining module 183, and an image generating module 184.

The information receiving module 181 is used for receiving and processing a vehicle inertial positioning information transmitted from the in-vehicle GPS terminal.

The information obtaining module 182 is used for obtaining a vehicle coordinate information and a vehicle driving information according to the processed vehicle inertial positioning information.

The map combining module 183 is used for combining the vehicle coordinate information and the vehicle driving information with a navigation map of the portable terminal.

The image generating module 184 is used for generating a navigation image according to the navigation map, the vehicle coordinate information and the vehicle driving information.

The in-vehicle GPS terminal includes an information transmitting module 185 and a navigation display module 186.

The information transmitting module 185 is used for transmitting the vehicle inertial positioning information to the portable terminal.

The navigation display module 186 is used for receiving and displaying the navigation map, the vehicle coordinate information and the navigation image transmitted from the portable terminal.

In the present invention, the vehicle inertial positioning information obtained by the in-vehicle GPS terminal is transmitted to the portable terminal so as to obtain a vehicle coordinate information and a vehicle driving information. A navigation image is generated and displayed according to a navigation map generated by a navigation software installed on the portable terminal in combination with the vehicle coordinate information and the vehicle driving information. Thus, the in-vehicle GPS terminal of the present invention can utilize the navigation software installed on the portable terminal which is connected to the in-vehicle GPS terminal to achieve vehicle navigation function by providing a vehicle inertial positioning information. Moreover, the present invention is convenient to use at lower cost.

The device disclosed in the present invention can be implemented by computer programs. Any person ordinarily skilled in the present technical field of technology should understand that the configuration of units or modules exemplified above is for exemplary purpose only. Any configurations of units or modules of the devices of the present invention are still within the scope of protection of the present invention as long as information elements can provide the above functions. It does not matter whether the configuration of units or modules remains the same or whether the devices are configured by units or modules.

Any person ordinarily skilled in the present technical field of technology should understand that the embodiments of the present invention can provide methods, devices (equipment), or computer program products. Therefore, the present invention can be implemented by hardware only, software only or a combination of software and hardware. Moreover, the present invention can be implemented by one or more than one computer program product whose computer-usable storage medium (such as but not limited to hard disc memory, CD-ROM, and optical memory) contains a computer-usable program code.

The present invention is described with reference to the flowcharts and/or block diagrams of the methods, devices (equipment), or computer program products of the embodiments of the present invention. Each step of a flowchart and/or each block of a block diagram or a combination thereof can be implemented by computer program instructions. The computer program instructions can be provided to general purpose computers, special purpose computers, embedded processors or processors of other programmable data processing apparatuses to generate a machine. Thus, instructions can be executed the computers and the processors of other programmable data processing apparatuses to implement a device capable of providing the functions specified in one or more than one step of a flowchart and/or or more than one block of a block diagram.

These computer program instructions can also be stored in a computer readable memory capable of guiding the computers or other programmable data processing apparatuses, such that the instructions stored in the computer readable memory can generate products including an instruction device. The instruction device implements the functions specified in one or more than one step of a flowchart and/or or more than one block of a block diagram.

These computer program instructions can also be loaded to computers or other programmable data processing apparatuses, such that a series of operation procedures can be executed on the computers or other programmable data processing apparatuses to provide the functions specified in one or more than one step of a flowchart and/or or more than one block of a block diagram.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A vehicle positioning method used on a portable terminal connected to an in-vehicle GPS terminal, wherein the method is characterized in that the method comprises:
receiving and processing a vehicle inertial positioning information transmitted from the in-vehicle GPS terminal;
obtaining a vehicle coordinate information and a vehicle driving information according to the processed vehicle inertial positioning information;
combining the vehicle coordinate information and the vehicle driving information with a navigation map of the portable terminal;
generating a navigation image according to the navigation map, the vehicle coordinate information and the vehicle driving information.

2. The method according to claim 1, wherein the method is characterized in that step of receiving and processing the vehicle inertial positioning information transmitted from the in-vehicle GPS terminal further comprises:
turning off a positioning function of the portable terminal to stop receiving a positioning information of the portable terminal.

3. The method according to claim 1, wherein the method is characterized in that step of receiving and processing the vehicle inertial positioning information transmitted from the in-vehicle GPS terminal further comprises:
receiving at least one of American GPS positioning information, Russian GLONASS positioning information, European Union GALILEO positioning information and Chinese Beidou positioning information, and using the received positioning information as a positioning information of the portable terminal.

4. The method according to claim 3, wherein the method is characterized in that the positioning information of the portable terminal further comprises a vehicle front-end orientation information of the in-vehicle GPS terminal.

5. The method according to claim 4, wherein the method is characterized in that the method further comprises:
receiving a local information request from the in-vehicle GPS terminal; and
transmitting a received local information to the in-vehicle GPS terminal.

6. The method according to claim 2, wherein the method is characterized in that the vehicle driving information comprises a wheel speed and a vehicle orientation angle.

7. The method according to claim 4, wherein the method is characterized in that the method further comprises:
receiving a traffic condition information from the in-vehicle GPS terminal;
wherein step of generating the navigation image according to the navigation map, the vehicle coordinate information and the vehicle driving information is implemented by:
generating and displaying the navigation image according to the traffic condition information, the navigation map, the vehicle coordinate information and the vehicle driving information.

8. The method according to claim 1, wherein the method is characterized in that the method further comprises:
transmitting the navigation image to the in-vehicle GPS terminal for display.

9. A vehicle positioning method used on an in-vehicle GPS terminal connected to a portable terminal, wherein the method is characterized in that the method comprises:
transmitting a vehicle inertial positioning information to the portable terminal; and
receiving and displaying a navigation map, a vehicle coordinate information and a navigation image transmitted from the portable terminal.

10. The method according to claim 9, wherein the method is characterized in that the method further comprises:
transmitting a local information request to the portable terminal; and
receiving a local information from the portable terminal.

11. The method according to claim 10, wherein the method is characterized in that the method further comprises:
transmitting an obtained traffic condition information to the portable terminal.

12. A portable terminal for vehicle positioning, wherein the portable terminal is connected to an in-vehicle GPS terminal and the portable terminal is characterized in that the portable terminal comprises:
an information receiving module used for receiving and processing a vehicle inertial positioning information transmitted from the in-vehicle GPS terminal;
an information obtaining module used for obtaining a vehicle coordinate information and a vehicle driving information according to the processed vehicle inertial positioning information;
a map combining module used for combining the vehicle coordinate information and the vehicle driving information with a navigation map of the portable terminal; and
an image generating module used for generating a navigation image according to the navigation map, the vehicle coordinate information and the vehicle driving information.

13. The portable terminal according to claim 12, wherein the portable terminal is characterized in that the information receiving module is further used for turning off a positioning function of the portable terminal to stop receiving a positioning information of the portable terminal.

14. The portable terminal according to claim 12, wherein the portable terminal is characterized in that the information receiving module is further used for receiving at least one of American GPS positioning information, Russian GLONASS positioning information, European Union GALILEO positioning information and Chinese Beidou positioning information, and using the received positioning information as a positioning information of the portable terminal.

15. The portable terminal according to claim 14, wherein the portable terminal is characterized in that the positioning information of the portable terminal further comprises a vehicle front-end orientation information of the in-vehicle GPS terminal.

16. The portable terminal according to claim 15, wherein the portable terminal is characterized in that the portable terminal further comprises:
an information requesting module used for receiving a local information request from the in-vehicle GPS terminal; and
an information providing module used for transmitting a received local information to the in-vehicle GPS terminal.

17. The portable terminal according to claim 12, wherein the portable terminal is characterized in that the vehicle driving information comprises a wheel speed and a vehicle orientation angle.

18. The portable terminal according to claim 17, wherein the portable terminal is characterized in that further comprises:
a traffic condition receiving module used for receiving a traffic condition information from the in-vehicle GPS terminal; and
the image generating module further used for generating a navigation image according to the traffic condition information, the navigation map, the vehicle coordinate information and the vehicle driving information.

19. The portable terminal according to claim 12, wherein the portable terminal is characterized in that the portable terminal further comprises:
an image displaying module used for transmitting the navigation image to the in-vehicle GPS terminal for display.

20. An in-vehicle GPS terminal for vehicle positioning, wherein the in-vehicle GPS terminal is connected to a portable terminal and the in-vehicle GPS terminal is characterized in that the in-vehicle GPS terminal comprises:
an information transmitting module used for transmitting a vehicle inertial positioning information to the portable terminal; and
a navigation display module used for receiving and displaying a navigation map, a vehicle coordinate information and a navigation image transmitted from the portable terminal.

21. The in-vehicle GPS terminal according to claim 20, wherein the in-vehicle GPS terminal is characterized in that the in-vehicle GPS terminal further comprises:
an instruction transmitting module used for transmitting a local information request to the portable terminal;
a local receiving module used for receiving a local information from the portable terminal.

22. The in-vehicle GPS terminal according to claim 21, wherein the in-vehicle GPS terminal is characterized in that the in-vehicle GPS terminal further comprises:
a traffic condition obtaining module used for transmitting an obtained traffic condition information to the portable terminal.
